(19) United States
(12) Patent Application Publication
(10) Pub. No.: US 2026/0128426 A1
(43) Pub. Date: May 7, 2026

(54) SECONDARY BATTERY AND ELECTRONIC DEVICE INCLUDING SAME

(71) Applicant: SAMSUNG SDI CO., LTD., Yongin-si (KR)

(72) Inventors: Sunyang HONG, Yongin-si (KR); Jeongchull AHN, Yongin-si (KR); Sanghyun KIM, Yongin-si (KR); Hiroshi SEINO, Yongin-si (KR)

(21) Appl. No.: 19/329,344

(22) Filed: Sep. 15, 2025

(30) Foreign Application Priority Data
Nov. 6, 2024 (KR) 10-2024-0156214

(51) Int. Cl. H01M 50/124; H01M 10/052; H01M 50/105; H01M 50/119; H01M 50/121

(52) U.S. Cl. CPC H01M 50/124; H01M 10/052; H01M 50/105; H01M 50/119; H01M 50/121

(57) ABSTRACT

A secondary battery according to embodiments of the present disclosure includes an electrode assembly including a first electrode in which a first electrode tab is formed, a second electrode in which a second electrode tab is formed, and a separator interposed between the first electrode and the second electrode, and a case configured to accommodate the electrode assembly, wherein the case includes a body including an accommodation part with one end opened in a first direction to accommodate the electrode assembly and a flange part extended from the opened one end along a direction different from the first direction, and a cover coupled to the flange part to seal the opened one end of the accommodation part, and wherein an edge of the flange part and the cover include a fixing part.

### CROSS-REFERENCE TO RELATED APPLICATION

The present application claims priority to and the benefit of Korean Patent Application No. 10-2024-0156214, filed on Nov. 6, 2024, in the Korean Intellectual Property Office, the entire disclosure of which is incorporated herein by reference.

### BACKGROUND

### 1. Field

The present disclosure relates to a secondary battery and an electronic device including the same, and more particularly, to a removable secondary battery and an electronic device including the same.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

Pouch-type secondary batteries that are flexible and light weight may be available due to changes in the component layout design and demands for lighter weight batteries as new models are launched. A separate fixing component such as a tape or a screw tab may be used for attaching or detaching the pouch-type battery to or from the electronic device. When a tape is used, wrinkles or deformations may occur in the exterior of the pouch when the tape is detached. Other problems may arise such as the battery being damaged due to the detachment from the electronic device because of weak adhesion provided by the tape. When a screw tab is used, separate components or processes are added, which generally increase the manufacturing cost and the production time.

The above information disclosed in this Background section is for enhancement of understanding of the background of the present disclosure, and therefore, it may contain information that does not constitute related (or prior) art.

### SUMMARY

One or more embodiments of the present disclosure provide a secondary battery and an electronic device including the same.

These and other aspects and features of the present disclosure will be described in or will be apparent from the following description of embodiments of the present disclosure.

However, aspects and features of the present disclosure are not limited to those described above, and other aspects and features not mentioned will be clearly understood by a person skilled in the art from the detailed description, described below.

According to some embodiments of the present disclosure, there is provided a secondary battery including an electrode assembly including a first electrode in which a first electrode tab is formed, a second electrode in which a second electrode tab is formed, and a separator interposed between the first electrode and the second electrode, and a case configured to accommodate the electrode assembly, wherein the case includes a body including an accommodation part with one end opened in a first direction to accommodate the electrode assembly and a flange part extended from the opened one end along a direction different from the first direction, and a cover coupled to the flange part to seal the opened one end of the accommodation part, wherein an edge of the flange part and the cover include a fixing part.

The at least one fixing part may be integrally formed with the case.

The at least one fixing part may include a through hole penetrating the flange part and the cover.

The at least one fixing part may include an end portion protruding diagonally from a center of the cover.

The end portion may have a square shape.

The body and the cover may include an outer layer that is exposed to an outside, a metal layer contacting the outer layer, and an inner layer contacting the metal layer.

The metal layer may include at least one of Aluminum (Al) or stainless steel (SUS).

The inner layer of the body and the inner layer of the cover may include Casted Polypropylene.

The flange part and the cover may be bonded through heat fusion between the inner layer of the body and the inner layer of the cover.

According to some embodiments of the present disclosure, there is provided an electronic device including an secondary battery, and a housing coupled to the secondary battery, wherein the secondary battery includes an electrode assembly including a first electrode in which a first electrode tab is formed, a second electrode in which a second electrode tab is formed, and a separator interposed between the first electrode and the second electrode, and a case configured to accommodate the electrode assembly, wherein the case includes a body including an accommodation part with one end opened in a first direction to accommodate the electrode assembly, and a flange part extended from the opened one end along a direction different from the first direction, and a cover coupled to the flange part to seal the opened one end of the accommodation part, wherein an edge of the flange part and the cover include at least one fixing part.

The housing may include a groove part for receiving the secondary battery, wherein a shape of the groove part corresponds to a shape of the secondary battery, wherein the groove part includes at least one coupling part coupled to a fixing member, and wherein the at least one fixing part of the secondary battery is coupled to the at least one coupling part through the fixing member.

The housing may include a guide part protruding from the housing, wherein a shape of the guide part corresponds to a shape of an edge of the secondary battery, and the secondary battery is for being placed inside the guide part, wherein at least one fixing part coupled to a fixing member is on the housing inside the guide part, and wherein the at least one fixing part of the secondary battery is coupled to the at least one coupling part through the fixing member.

The electronic device may include a frame placed on the secondary battery, the frame having a shape corresponding to a shape of the flange part and the at least one fixing part of the secondary battery.

The at least one fixing part may be integrally formed with the case.

The at least one fixing part may include a through hole penetrating the flange part and the cover.

The at least one fixing part may include an end portion diagonally protruding from a center of the cover.

The body and the cover may include an outer layer exposed to an outside, a metal layer contacting an outer layer, and an inner layer contacting the metal layer.

The metal layer may include at least one of Aluminum or stainless steel.

The inner layer of the body and the inner layer of the cover may include Casted Polypropylene.

The flange part may be bonded to the cover through heat fusion between the inner layer of the body and the inner layer of the cover.

According to some embodiments of the present disclosure, manufacturing at least one fixing part 210 capable of coupling a fixing member such as a screw or a fixing pin in advance may minimize additional processes and prevent deterioration of characteristics such as dismantling, reusability, and exterior deformation due to dropping of the secondary battery.

According to some embodiments of the present disclosure, there is no need to attach a separate component to a secondary battery for integration with an electronic device, and thus no concern arises about strain occurring due to the structural difference between the component and the secondary battery, thereby enhancing the structural stability of the secondary battery.

According to some embodiments, the fixing force may be increased by forming a groove part or a guide part corresponding to the shape of the secondary battery, so that the drop resistance of the secondary battery may be improved.

According to some embodiments of the present disclosure, the integration degree of the electronic device may be improved by additionally arranging another device on the secondary battery.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a view illustrating a secondary battery according to one or more embodiments of the present disclosure;

FIG. 2 is a view illustrating a case of a secondary battery according to one or more embodiments of the present disclosure;

FIG. 3 is a schematic view illustrating a part of an electronic device including a secondary battery according to one or more embodiments of the present disclosure;

FIG. 4 is a schematic view illustrating a part of an electronic device including a secondary battery according to one or more embodiments of the present disclosure;

FIG. 5 is a schematic view illustrating an electronic device including a secondary battery according to one or more embodiments of the present disclosure;

FIG. 6, FIG. 7, and FIG. 8 depict a secondary battery that undergoes a manufacturing method according to one or more embodiments of the present disclosure; and

FIG. 9 is a flowchart of a process for manufacturing an electronic device according to one or more embodiments of the present disclosure.

### DETAILED DESCRIPTION

Hereinafter, embodiments of the present disclosure will be described, in detail, with reference to the accompanying drawings. The terms or words used in the present specification and claims not be construed as being limited to the general or dictionary meanings and should be interpreted as meanings and concepts that are consistent with the technical idea of the present disclosure on the basis of the principle that an inventor may be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that may replace or modify the embodiments described herein at the time of filing this application.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section.

Thus, a first element, component, region, layer, or section discussed below could be termed a second element, component, region, layer, or section without departing from the teachings of example embodiments.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements. In addition, it will be understood that when a component is referred to as being “linked,” “coupled,” or “connected” to another component, the elements may be directly “coupled,” “linked” or “connected” to each other, or another component may be “interposed” between the components”.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein.

Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

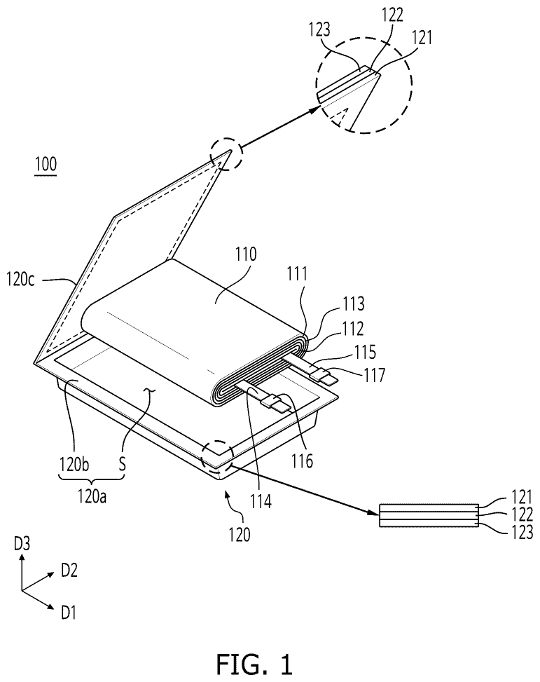

FIG. 1 is a view illustrating a secondary battery 100 according to one or more embodiments of the present disclosure. Referring to FIG. 1, a secondary battery 100 may include an electrode assembly 110 including a first electrode 111 in which a first electrode tab 114 is formed, a second electrode 112 in which a second electrode tab 115 is formed, a separator interposed between the first electrode 111 and the second electrode 112, and a case 120 that accommodates the electrode assembly 110.

According to some embodiments, the electrode assembly 110 may be wound or stacked with the separator 113 interposed between the first electrode 111 corresponding to a positive electrode and the second electrode 112 corresponding to a negative electrode. The secondary battery 100 shown in FIG. 1 is a pouch-typed secondary battery, but the secondary battery according to one or more embodiments is not limited thereto, and may be of various types.

The positive electrode and the negative electrode may include a coated portion in which a current collector formed of a thin film foil coated with an active material and a non-coated portion in which a current collector is not coated with an active material. The positive electrode and the negative electrode are wound with an insulating separator interposed therebetween. However, the present disclosure is not limited thereto, and the electrode assembly may have a structure in which positive electrodes and negative electrodes formed of a plurality of sheets are alternately stacked with a separator interposed therebetween.

A positive electrode for a rechargeable lithium battery may include a current collector and a positive electrode active material layer on the current collector. The positive electrode active material layer may include a positive electrode active material and may further include a binder and/or a conductive material (e.g., an electrically conductive material).

For example, the positive electrode may further include an additive that may serve as a sacrificial positive electrode.

An amount of the positive electrode active material may be about 90 wt % to about 99.5 wt % based on 100 wt % of the positive electrode active material layer.

Amounts of the binder and the conductive material may be about 0.5 wt % to about 5 wt %, respectively, based on 100 wt % of the positive electrode active material layer.

In some embodiments, the binder serves to attach the positive electrode active material particles to each other. The binder may also be used to attach the positive electrode active material to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and/or the like, as non-limiting examples.

The conductive material may be used to impart conductivity (e.g., electrical conductivity) to the electrode. Any material that does not cause chemical change (e.g., does not cause an undesirable chemical change in the rechargeable lithium battery) and conducts electrons may be used in the battery. Examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as a polyphenylene derivative; or a mixture thereof.

Aluminum (Al) may be used as the current collector, but is not limited thereto.

The separator may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and/or the like.

The negative electrode for a rechargeable lithium battery may include a current collector and a negative electrode active material layer on the current collector. The negative electrode active material layer may include a negative electrode active material, and may further include a binder and/or a conductive material (e.g., an electrically conductive material).

For example, the negative electrode active material layer may include about 90 wt % to about 99 wt % of the negative electrode active material, about 0.5 wt % to about 5 wt % of the binder, and about 0 wt % to about 5 wt % of the conductive material.

The binder may serve to attach the negative electrode active material particles to each other. The binder may also be used to attach the negative electrode active material to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be selected from a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, or a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include Na, K, or Li.

The dry binder may be a polymer material that is capable of being fibrous. For example, the dry binder may be polytetrafluoroethylene, polyvinylidene fluoride, a polyvinylidene fluoride-hexafluoropropylene copolymer, polyethylene oxide, or a combination thereof.

The conductive material may be used to impart conductivity (e.g., electrical conductivity) to the electrode. Any material that does not cause chemical change (e.g., does not cause an undesirable chemical change in the rechargeable lithium battery) and that conducts electrons may be used in the battery. Non-limiting examples thereof may include a carbon-based material such as natural graphite, artificial graphite, carbon black, acetylene black, ketjen black, a carbon fiber, a carbon nanofiber, and a carbon nanotube; a metal-based material including copper, nickel, aluminum, silver, etc. in a form of a metal powder or a metal fiber; a conductive polymer such as a polyphenylene derivative; or a mixture thereof.

The negative current collector may include a copper foil, a nickel foil, a stainless steel foil, a titanium foil, a nickel foam, a copper foam, a polymer substrate coated with a conductive metal, or a combination thereof.

The separator may include a porous substrate and a coating layer including an organic material, an inorganic material, or a combination thereof on one or both surfaces of the porous substrate.

The porous substrate may be a polymer film formed of any one selected from a polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked.

The first electrode tab 114 and the second electrode tab 115 may be connected to the non-coated portions of the first electrode 111 and the second electrode 112 by welding, or may be formed by punching the non-coated portions of the first electrode 111 and the second electrode 112. The first electrode tab 114 and the second electrode tab 115 may be arranged parallel to each other with a set gap when wound. The electrode assembly 110 may be an arbitrary structure including electrode tabs. Tab films 116 and 117 for insulation from the case 120 may be attached to the first electrode tab 114 and the second electrode tab 115.

The case 120 may include a body 120a including an accommodation part S for accommodating the electrode assembly 110 with one end being open in a first direction D3 and a flange part 120b extending from the open one end along a direction different from the first direction D3 (e.g., direction D1 or direction D2), and a cover 120c coupled to the flange part 120b to seal the open one end of the accommodation part S. The case 120 may form the overall exterior of the secondary battery 100. The accommodation part S for accommodating the electrode assembly 110 may be formed in the body 120a by a press processing, etc. The cover 120c may be formed in a flat plate placed on the top of the case 120 to seal the accommodation part S. For example, the cover 120c may be formed in a flat plate having a size to cover the flange part 120b to form surface contact with the flange part 120b. The bottom of the cover 120c and the top of the flange part 120b may be arranged to form surface contact with each other. The body 120a and the cover 120c may form a single bonding structure through the bonding of the flange part 120b and the cover 120c. According to some embodiments, the body 120a may be bonded to the cover 120c by laser welding. However, the bonding method in the present disclosure is not limited thereto, and various bonding methods capable of sealing the case 120 may be applied. For example, the cover 120c and the flange part 120b may be bonded by not only laser welding but also ultrasonic welding, brazing, laser brazing, welding, soldering, etc.

According to one or more embodiments, the body 120a and the cover 120c may include an outer layer 123 exposed to the outside, a metal layer 122 in contact with the outer layer, and an inner layer 121 in contact with the metal layer 122. The outer layer 123 may include polyethylene terephthalate (PET) or nylon. The metal layer 122 may include at least one of aluminum (Al) and stainless steel (SUS). The inner layer 121 may include an olefin resin layer such as casted polypropylene. The flange part 120b and the cover 120c may be bonded through heat fusion between the inner layers 121 of the body 120a and the cover 120c.

According to some embodiments, at least one fixing part may be formed on the edge of the cover 120c. The detailed description on the at least one fixing part will be detailed below.

The secondary battery 100 may be a lithium battery cell, a sodium battery cell, etc. However, the scope of the present disclosure is not limited thereto, and the secondary battery 100 may include all batteries that may provide electricity (e.g., repeatedly) by being charged and discharged. According to some embodiments, when the secondary battery 100 is a lithium battery cell, the lithium battery cell may be used as the secondary battery in an electric vehicle (EV) as having increased life characteristic and high-rate characteristic. For example, the lithium battery cell may be used in a hybrid vehicle such as a plug-in hybrid electric vehicle (PHEV). In some embodiments, the lithium battery cell may be used in small portable electronic devices such as a smartphone, a laptop computer, a camcorder, etc., but it is not limited thereto.

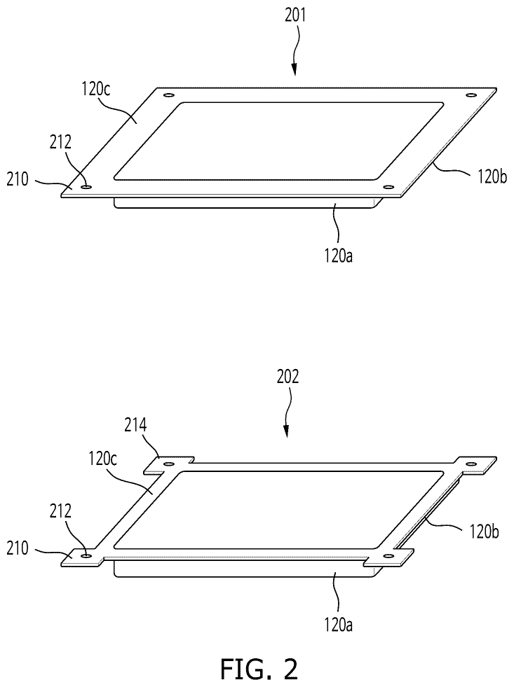

FIG. 2 is a view illustrating cases 201 and 202 of a secondary battery 100 according to embodiments of the present disclosure. The cases 201 and 202 including a body 120a, a flange part 120b, and a cover 120c may refer to a configuration that performs the function of the case 120 shown in FIG. 1. Referring to FIG. 2, at least one fixing part 210 may be formed on the edge of the cover 120c. According to some embodiments, the shapes of the flange part 120b and the cover 120c of the case 201 may be rectangular, and the at least one fixing part 210 may be formed near the edge of the flange part 120b and the cover 120c of the case 201. In this regard, the edge of the flange part 120b and the cover 120c may include the at least one fixing part 210.

At least one fixing part 210 may be integrally formed with the case 201. At least a part of the flange part 120b and the cover 120c may form at least one fixing part 210. In some embodiments, the at least one fixing part 210 may be formed as a part of the case 210 without having a particular shape.

According to some embodiments, the case 202 may include the at least one fixing part 210 including an end portion 214 formed by diagonally protruding from the center of the cover 120c. The shape of the end portion 214 may be square, but it is not limited thereto, but may vary. At least one fixing part 210 may be integrally formed with the case 202. A part of the flange part 120b and the cover 120c may form at least one fixing part 210.

According to some embodiments, at least one fixing part 210 may include a through hole 212 formed by penetrating the flange part 120b and the cover 120c. The through hole 212 may be formed at the center of at least one fixing part 210, but the location of the through hole 212 is not limited thereto. Manufacturing at least one fixing part 210 capable of coupling a fixing member such as a screw or a fixing pin in advance may minimize additional processes and prevent or reduce deterioration of characteristics such as dismantling, reusability, and exterior deformation due to the secondary battery being dropped. In some embodiments, there is no need or reduced need to attach a separate component to a secondary battery for integration with an electronic device, and thus there may be reduced concern or no concern about strain occurring due to the structural difference between the component and the secondary battery, helping enhance the structural stability of the secondary battery.

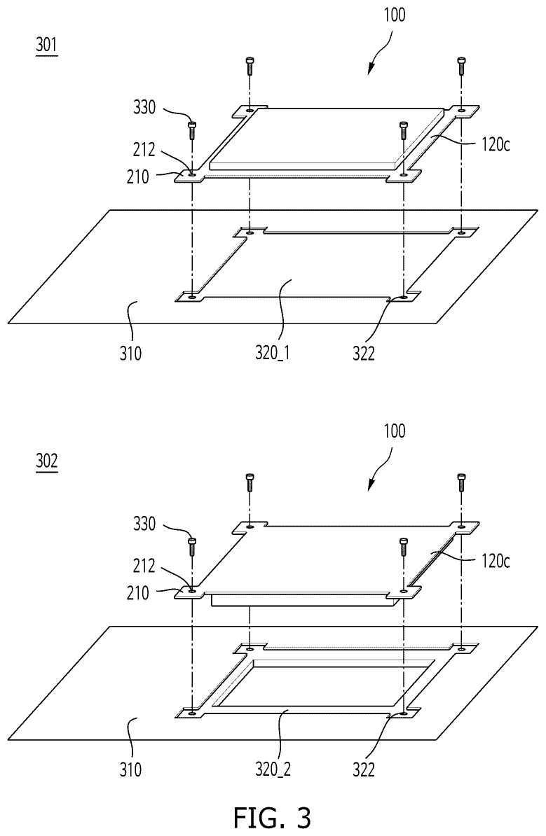

FIG. 3 is a schematic view illustrating a part of electronic devices 301 and 302 including an secondary battery 100 according to embodiments. Referring to FIG. 3, electronic devices 301 and 302 may include a secondary battery 100 and a housing 310 coupled to the secondary battery 100. The detailed description on the secondary battery 100 redundant from the description in FIG. 1 and FIG. 2 will be omitted.

The electronic devices 301 and 302 may use the secondary battery 100 as a part or all of power source. When the secondary battery 100 is used as a part of the power source, direct AC power may be used when AC power is activated, and when the device is portable, the device may be driven (e.g., only driven) by the secondary battery 100. The electronic devices 301 and 302 according to embodiments of the present disclosure may be applied to various small electronic devices including smartphones, mobile phones, PDAs, and laptop computers, but the present disclosure is not limited thereto.

The housing 310 may include grooves 320_1 and 320_2 in which the secondary battery 100 is placed. The shape of the grooves 320_1 and 320_2 may correspond to the shape of the secondary battery 100. For example, when the shape of the groove 320_1 corresponds to one surface of the secondary battery 100, the shape of the groove 320_2 may correspond to the other surface of the secondary battery 100. In some embodiments, the shape of the groove 320_1 may correspond to the shape of the cover 120c, and the shape of the groove 320_2 may correspond to the shape of the opposite side of the cover 120c. In some embodiments, the shape of the groove 320_2 may correspond to the shape of the cover 120c, and the shape of the groove 320_1 may correspond to the shape of the opposite side of the cover 120c. The groove 320_1 and 320_2 may be formed by removing a part of the housing 310. The groove 320_1 and 320_2 may include at least one coupling part 322 coupled to a fixing member 330, and at least one fixing part 210 of the secondary battery 100 may be coupled to the at least one coupling part 322 through a fixing member 330. For example, the through hole 212 of at least one fixing part 210 and the through hole of at least one coupling part may be coupled by a screw. The secondary battery 100 may be embedded in the electronic devices 301 and 302 by the groove 320_1 and 320_2, and in some embodiments, the fixing force may be increased, and the drop resistance of the secondary battery 100 may be improved. In some embodiments, the integration degree of the electronic devices 301 and 302 may be improved by additionally arranging another device on the secondary battery.

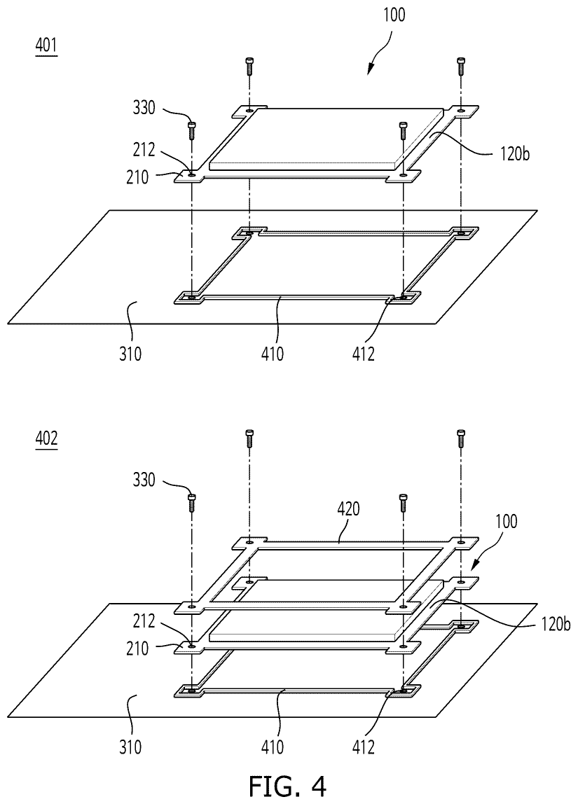

FIG. 4 is a schematic view illustrating a part of electronic devices 401 and 402 including a secondary battery 100 according to some embodiments. Referring to FIG. 4, electronic devices 401 and 402 may include a secondary battery 100 and a housing 310 coupled to the secondary battery 100. The redundant description for the secondary battery 100 from FIG. 1 and FIG. 2 will be omitted.

The electronic devices 401 and 402 may use the secondary battery 100 as a part of all of power source. When the secondary battery 100 is used as a part of the power source, direct AC power may be used in an environment where AC power is activated, and when the device is portable, the device may be driven (e.g., only driven) with the secondary battery 100. The electronic devices 401 and 402 according to embodiments may be applied to various small electronic appliances such as smartphones, portable phones, PDAs, laptop computers, and/or the like.

The housing 310 may include a guide part 410 that protrudes from the housing 310. In some embodiments, the guide part 410 corresponding to the shape and the size of the housing 310 may be separately formed to be placed in the housing 310. The shape of the guide part 410 may correspond to the shape of the edge of the secondary battery 100, and the secondary battery 100 may be arranged inside the guide part 410.

At least one coupling part 412 to which a fixing member 330 is coupled may be formed on the housing 310 inside the guide part 410. At least one fixing part 210 of the secondary battery 100 may be coupled to at least one coupling part 412 through the fixing member 330. For example, a through hole 212 of the at least one fixing part 210 and a through hole of at least one coupling part 412 may be coupled by a screw.

According to some embodiments, a frame 420 having a shape corresponding to the shape of the flange part 120b of the secondary battery 100 and at least one fixing part 210 may be disposed in the electronic device 402. The frame 420 may be coupled to the secondary battery 100 and the housing 310 through the fixing member 330. For example, the frame 420 may include a through hole in a position corresponding to a through hole of at least one fixing part 210 and a through hole of at least one coupling part 412.

The through hole of the at least one fixing part 210, the through hole of the at least one coupling part 412, and the through hole of the frame 420 may be combined or coupled by the fixing member 330. The thickness of the frame 420 may be smaller than the thickness of the secondary battery 100. The fixing force of the secondary battery 100 may be improved when the frame 420 and the guide part 410 are attached to the electronic device 402.

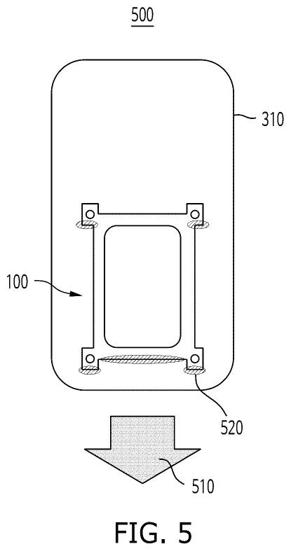

FIG. 5 is a schematic view illustrating an electronic device 500 including a secondary battery 100 according to some embodiments. Referring to FIG. 5, The electronic device 500 may use the secondary battery 100 as a part or all of power source. When the secondary battery 100 is used as a part of the power source, direct AC power may be used in an environment where AC power is activate, and when the device is portable, the device may be driven (e.g., only driven) by the secondary battery 100. The electronic device 500 according to embodiments of the present disclosure may be applied to various small electronic devices including smartphones, mobile phones, PDAs, and laptop computers, but the present disclosure not limited thereto. The housing 310 of the electronic device 500 may fix the secondary battery 100. The housing 310 may include grooves 320_1 and 320_2 or a guide part 410 illustrated in FIG. 3 or FIG. 4. A fixing force may be generated by arranging and fixing the secondary battery 100 to the groove part or the guide part of the housing 310 of the electronic device 500, to help minimize or suppress vibration in a falling direction 510 and vibration that may occur after falling in the opposite direction of the falling direction 510 (e.g., when the battery is dropped).

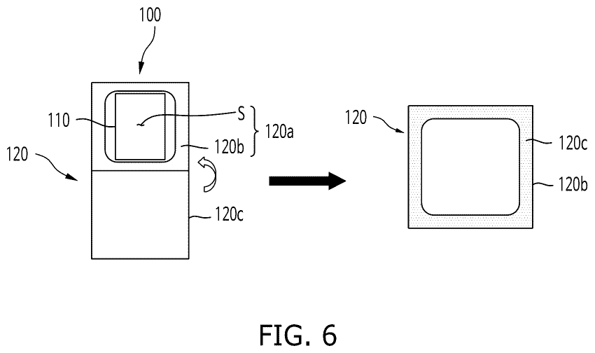

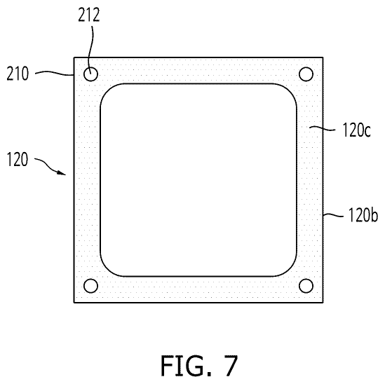

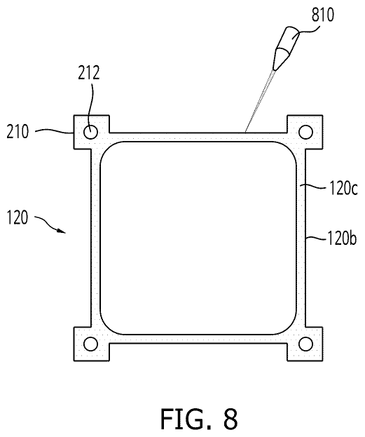

FIG. 6 to FIG. 8 depict a secondary battery 100 that undergoes a manufacturing method according to one or more embodiments of the present disclosure. Referring to FIG. 6, an electrode assembly 110 may be accommodated in an accommodation part S of a body 120a of a case 120, and a cover 120c and a flange part 120b may be coupled. For example, the cover 120c and the flange part 120b may be bonded through heat fusion. The detailed description of the electrode assembly 110, the case 120, the body 120a, the accommodation part S, the flange part 120b, and the cover 120c has been described in detail in FIG. 1, and the redundant description thereof will be omitted.

Referring to FIG. 7, at least one fixing part 210 may be formed on the edge of the cover 120c. According to one embodiment, the shapes of the flange part 120b and the cover 120c of the case 201 may be rectangular, and at least one fixing part 210 may be formed near a corner of the flange part 120b and the cover 120c of the case 201. The at least one fixing part 210 may be formed integrally with the case 201. In some embodiments, a portion of the flange part 120b and the cover 120c may form the at least one fixing part 210. According to one embodiment, the at least one fixing part 210 may include a through hole 212 formed by penetrating the flange part 120b and the cover 120c. The through hole 212 may be formed in the center of at least one fixing part 210, but the location of the through hole 212 is not limited thereto. According to some embodiments, the through hole 212 may be formed by a process including punching or the like.

Referring to FIG. 8, at least one fixing part 210 may be formed as an end portion that diagonally protrudes from the center of the cover 120c. According to some embodiments, the part of the flange part 120b and the cover 120c may be cut by a cutting machine 810 to form the end portion of the at least one fixing part 210. For example, the cutting machine 810 may be a laser cutting machine.

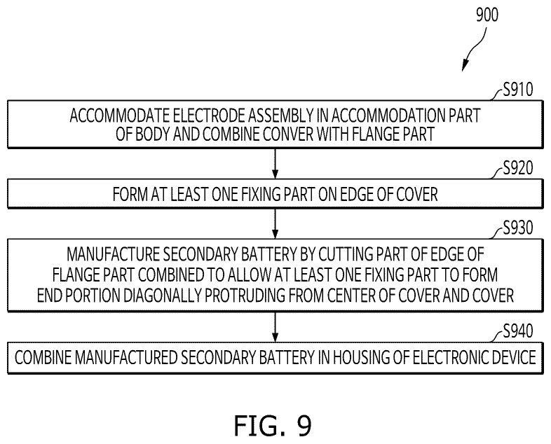

FIG. 9 is a flowchart 900 of a processor for manufacturing an electronic device according to one or more embodiments of the present disclosure. Referring to FIG. 9, the flowchart 900 may be initiated by performing step S910 of accommodating an electrode assembly in an accommodation part of a body and combining a cover with a flange part. For example, referring to FIGS. 1 and 6, the electrode assembly 110 may be wound or stacked with an insulating separator 113 interposed between a first electrode 111 corresponding to a positive electrode and a second electrode 112 corresponding to a negative electrode. A body 120a may be included in a case 120 and may include an accommodation part S for accommodating the electrode assembly 110 with one end being open in a first direction D3, and a flange part 120b extending from the open one end in a direction different from the first direction D3 (e.g., direction D1 or direction D2). The cover 120c may be formed in a flat substrate placed on the top of the case 120 to seal the accommodation part S. For example, the cover 120c may be formed in a flat substrate having a size sufficient to cover the flange part 120b to form surface contact with the flange part 120b. The bottom of the cover 120c and the top of the flange part 120b may be placed to form surface contact with each other. The body 120a and the cover 120c may form a single bonding structure by bonding the flange part 120b to the cover 120c.

Step S920 of forming at least one fixing part on the edge of the cover may be performed. For example, referring to FIG. 2 and FIG. 7, at least one fixing part 210 may be formed on the edge of the cover 120c. The at least one fixing part 210 may include a through hole 212 formed by penetrating the flange part 120b and the cover 120c. The through hole 212 may be formed at the center of the at least one fixing part 210, but the location of the through hole 212 is not limited thereto. The through hole 212 may be formed through a process such as punching.

Step S930 of manufacturing a secondary battery by cutting a part of the edge of the flange part and the cover bonded to form an end portion that diagonally protrudes from the center of the cover by at least one fixing part may be performed. For example, referring to FIG. 2, at least one fixing part 210 of the case 202 may include an end portion 214 that diagonally protrudes from the center of the cover 120c. The shape of the end portion 214 may be a square, but it is not limited thereto. According to some embodiments, a part of the edge of the flange part 120b the cover 120c may be cut by using a laser cutting machine, etc. The secondary battery may be equivalent to the secondary battery 100 according to embodiments of the present disclosure illustrated in FIG. 1 to FIG. 5.

Step S940 of combining the secondary battery in the housing of the electronic device may be performed. For example, referring to FIG. 5, the dismantlability, reusability, and deterioration of characteristics due to exterior deformation caused by dropping of the secondary battery 100 may be reduced or prevented by combining the secondary battery 100 with the housing 310 of the electronic device 500.

Although the present disclosure has been described with reference to embodiments and drawings illustrating aspects thereof, the present disclosure is not limited thereto. Various modifications and variations may be made by a person skilled in the art to which the present disclosure belongs within the scope of the technical spirit of the present disclosure and the claims and their equivalents, below.

### DESCRIPTION OF SYMBOLS

100: Secondary Battery
110: Electrode Assembly
111: First Electrode
112: Second Electrode
113: Separator
114: First Electrode Tab
115: Second Electrode Tab
116, 117: Insulating Tape
120: Case
S: Accommodation Part
120a: Body
120b: Flange Part
120c: Cover
121: Inner Layer
122: Metal Layer
123: Outer Layer

What is claimed is:

1. A secondary battery, comprising:
an electrode assembly comprising a first electrode having a first electrode tab formed thereon, a second electrode having a second electrode tab formed thereon, and a separator interposed between the first electrode and the second electrode; and
a case configured to accommodate the electrode assembly,
wherein the case comprises:
a body comprising an accommodation part with opened one end in a first direction to accommodate the electrode assembly and a flange part extended from the opened one end along a direction different from the first direction; and
a cover coupled to the flange part to seal the opened one end of the accommodation part, and
wherein an edge of the flange part and the cover include at least one fixing part.

2. The secondary battery as claimed in claim 1, wherein the at least one fixing part is integrally formed with the case.

3. The secondary battery as claimed in claim 1, wherein the at least one fixing part comprises a through hole penetrating the flange part and the cover.

4. The secondary battery as claimed in claim 1, wherein the at least one fixing part comprises an end portion protruding diagonally from a center of the cover.

5. The secondary battery as claimed in claim 4, wherein the end portion has a square shape.

6. The secondary battery as claimed in claim 1, wherein the body and the cover comprise an outer layer exposed to an outside, a metal layer contacting the outer layer, and an inner layer contacting the metal layer.

7. The secondary battery as claimed in claim 6, wherein the metal layer comprises at least one of Aluminum (Al) or stainless steel (SUS).

8. The secondary battery as claimed in claim 6, wherein the inner layer of the body and the inner layer of the cover comprise Casted Polypropylene.

9. The secondary battery as claimed in claim 8, wherein the flange part and the cover are bonded via heat fusion between the inner layer of the body and the inner layer of the cover.

10. An electronic device, comprising:
a secondary battery; and
a housing coupled to a secondary battery,
wherein the secondary battery comprises:
an electrode assembly comprising a first electrode having a first electrode tab formed thereon, a second electrode having a second electrode tab formed thereon, and a separator interposed between the first electrode and the second electrode; and
a case configured to accommodate the electrode assembly,
wherein the case comprises:
a body comprising an accommodation part with opened one end in a first direction to accommodate the electrode assembly, and a flange part extended from the opened one end along a direction different from the first direction; and
a cover coupled to the flange part to seal the opened one end of the accommodation part, and
wherein an edge of the flange part and the cover include at least one fixing part.

11. The electronic device as claimed in claim 10, wherein the housing comprises a groove part for receiving the secondary battery,
wherein a shape of the groove part corresponds to a shape of the secondary battery,
wherein the groove part comprises at least one coupling part coupled to a fixing member, and
wherein the at least one fixing part of the secondary battery is coupled to the at least one coupling part via the fixing member.

12. The electronic device as claimed in claim 10, wherein the housing comprises a guide part protruding from the housing,
wherein a shape of the guide part corresponds to a shape of an edge of the secondary battery,
wherein the secondary battery is for being placed inside the guide part,
wherein at least one fixing part coupled to a fixing member is on the housing inside the guide part, and
wherein the at least one fixing part of the secondary battery is coupled to the at least one coupling part via the fixing member.

13. The electronic device as claimed in claim 12, wherein the electronic device further comprises a frame placed on the secondary battery, the frame having a shape corresponding to a shape of the flange part and the at least one fixing part of the secondary battery.

14. The electronic device as claimed in claim 10, wherein the at least one fixing part is integrally formed with the case.

15. The electronic device as claimed in claim 10, wherein the at least one fixing part comprises a through hole penetrating the flange part and the cover.

16. The electronic device as claimed in claim 10, wherein the at least one fixing part comprises an end portion diagonally protruding from a center of the cover.

17. The electronic device as claimed in claim 10, wherein the body and the cover comprise an outer layer exposed to an outside, a metal layer contacting the outer layer, and an inner layer contacting the metal layer.

18. The electronic device as claimed in claim 17, wherein the metal layer comprises at least one of Aluminum or stainless steel.

19. The electronic device as claimed in claim 17, wherein the inner layer of the body and the inner layer of the cover comprise Casted Polypropylene.

20. The electronic device as claimed in claim 19, wherein the flange part is bonded to the cover via heat fusion between the inner layer of the body and the inner layer of the cover.
